(19) United States
(12) Patent Application Publication
(10) Pub. No.: US 2016/0101751 A1
(43) Pub. Date: Apr. 14, 2016

(54) FRONT STRUCTURE FOR A MOTOR VEHICLE

(71) Applicants: TOYOTA MOTOR EAST JAPAN, INC., Kurokawa-gun (JP); TOYOTA JIDOSHA KABUSHIKI KAISHA, Toyota-shi (JP)

(72) Inventors: Eikyo BOU, Miyagi (JP); Isao SOUTOME, Miyagi (JP); Masatoshi ABE, Toyota-shi (JP)

(73) Assignees: TOYOTA MOTOR EAST JAPAN, INC., Kurokawa-gun (JP); TOYOTA JIDOSHA KABUSHIKI KAISHA, Toyota-shi (JP)

(21) Appl. No.: 14/874,506

(22) Filed: Oct. 5, 2015

(30) Foreign Application Priority Data
Oct. 10, 2014 (JP) 2014-208844

(51) Int. Cl. B60R 19/34; B60R 19/02

(52) U.S. Cl. CPC B60R 19/34; B60R 19/023; B60R 2019/247

(57) ABSTRACT

A vehicle front structure having a bumper reinforcement arranged in the vehicle width direction at the front part of a pair of front side members is provided. A pair of extensions is provided to the bumper reinforcement at positions outside of the front side members in the vehicle width direction. Each extension is provided with a front protrusion protruding ahead of the bumper reinforcement at positions outside of the front side member on the front side, and a rear protrusion protruding backward on the rear side. At the time of a small overlap frontal crash, loads imposed on the extension are transmitted to and absorbed by the front side member by the rear protrusion via the front protrusion.

### CROSS REFERENCE TO RELATED APPLICATIONS

This application claims priority based on 35 U.S.C. 119 from prior Japanese Patent Application No. 2014-208844 filed Oct. 10, 2014, entitled “Front structure for a motor vehicle,” which is incorporated herein by reference in its entirety.

### BACKGROUND OF THE INVENTION

1. Field of the Invention

The present invention relates to a front structure for a motor vehicle, in which extensions are provided on the outside of a bumper reinforcement in the vehicle width direction. More particularly, the present invention relates to the bumper reinforcement extending in the vehicle width direction and being supported by a pair of front side members that extend in the vehicle front-rear direction, and loads produced in a small overlap frontal crash are transmitted to the front side members via these extensions.

2. Description of the Related Art

In a conventional vehicle front structure having a bumper reinforcement extending in a vehicle width direction and supported by a pair of front side members that extend in a vehicle front-rear direction, a pair of extensions is provided generally on the outside of the bumper reinforcement in the vehicle width direction. This pair of extensions extends from a part where the front side members on both sides abut on the bumper reinforcement to further outside on both sides. With such a structure, loads from a small overlap frontal crash (a crash with another vehicle allowing an offset toward the front-left or front-right side of the vehicle) are transmitted to the front side member via the extensions. A small overlap frontal crash is one of the forms of offset frontal crashes.

In Patent Literature 1, for example, the extension of a bumper reinforcement and the outer face of a front side member are connected by a connecting element. In this structure, the extension of the bumper reinforcement is supported by the connecting element when a small overlap frontal crash occurs, and the connecting member coupled with the front side member deforms along with a crash box, thereby preventing the bumper reinforcement from being deformed.

In Patent Literature 2, load transmitting members are fastened to the extensions of a bumper reinforcement, more specifically at positions where the load transmitting members overlap with the front side member in the vehicle width direction. In this structure, one of the crash boxes is compressed and deformed, and the load transmitting member abuts on the outside of the front side member, when a small overlap frontal crash occurs. Consequently, inward component of force of crash loads in the vehicle width direction is transmitted from the bumper reinforcement to one of the front side members via the load transmitting member.

### CITATION LIST

### Patent Literature

Patent Literature 1: JP 2013-169866 A

Patent Literature 2: JP 2013-223820 A

Patent Literature 3: JP 2008-213739 A

Patent Literature 4: JP 2008-162344 A

Patent Literature 5: JP 2014-136537 A

With conventional vehicle front structures, loads produced by a small overlap frontal crash are made to be transmitted from an extension to a front side member. With any of these structures, if the position of a colliding body hitting a vehicle in a small overlap frontal crash varies in the vehicle width direction, sharing of loads by parts in the front part of the vehicle such as bumper reinforcement and front side members, abutting positions, deformation timing, etc. are far from being stabilized.

### SUMMARY

The purpose of the present invention is to provide a vehicle front structure capable of absorbing loads more stably even if the relative position of a colliding body and a vehicle varies in the vehicle width direction.

### SOLUTION TO PROBLEM

To achieve the objective described above, the present invention provides a vehicle front structure, in which a bumper reinforcement is supported in a vehicle width direction at the front of the vehicle by a pair of front side members arranged in a driving direction on both sides in the vehicle width direction, extensions are provided to the bumper reinforcement at positions outside of the part supported by the front side members in the vehicle width direction, and loads imposed to a part outside of the front side member in the vehicle width direction are transmitted to the front side member via the extension. Each extension is provided, on its front side, with a front protrusion that protrudes ahead of the bumper reinforcement at a position outside of the part supported by the front side member, and on its rear side, with a rear protrusion that abuts on the front side member in the case of a small overlap frontal crash.

At the front part of the front side members, a pair of weakened portions is provided to weaken the rigidity of the part near the front end of the front side members, and respectively fastened to the left- and right-side rear face of the bumper reinforcement. The weakened portion is preferably a crash box. In the case of a frontal crash, the crash box can undergo compression deformation in an axial direction, whereas in the case of a small overlap frontal crash, abutting of the rear protrusion of the extension on the weakened portion allows bending deformation to occur.

The extension may be integrated with the bumper reinforcement into one piece, constituting a part of the bumper reinforcement. The extension is curved moderately toward the back of the vehicle along the direction toward the outside in the vehicle width direction. It is desirable that the length of the curving extension be set shorter than the length of the weakened portion in the vehicle front-rear direction.

The front protrusion desirably has, on the front side of the extension, a front end positioned forward toward the front side of the vehicle, a vertical wall on the outside in the vehicle width direction, and a vertical wall on the inside in the vehicle width direction, and the vertical wall on the outside in the vehicle width direction is preferably formed longer, in the vehicle front-rear direction, than the vertical wall on the inside in the vehicle width direction.

The front protrusion is desirably arranged, with a specified gap with the foremost edge of the bumper reinforcement allowed in the vehicle front-back direction, so that its front end is positioned behind the foremost edge of the bumper reinforcement placed between the front side members. It is further desirable that the front end be positioned ahead of the foremost face of the bumper reinforcement at positions outside the part supported by the front side member.

The rear protrusion protrudes on the rear side of the extension toward the center of the weakened portion in the vehicle front-rear direction and is desirably arranged in a state not connected with the weakened portion.

According to the present invention, at the time of a frontal crash, the front protrusion and the extension deform toward the front side of the vehicle, and accordingly, the rear protrusion displaces toward the front side of the vehicle. Meanwhile, at the time of a small overlap frontal crash, the front protrusion contacts a colliding body at the initial contact position, pressing down the extension toward the rear side of the vehicle and thus causing the rear protrusion to abut on the weakened portion, which undergoes bending deformation.

According to the present invention, the extension is provided with a front protrusion protruding ahead of the bumper reinforcement at a position outside of the part supported by the front side member. Consequently, when loads from a colliding body are imposed on the extension in a small overlap frontal crash, the front protrusion abuts on the colliding body first, even if the relative position between the colliding body and the vehicle varies. In other words, the position of the loads from the front colliding body imposed on the extension is stabilized. Furthermore, the extension is provided with a rear protrusion that abuts on the front side member at the time of a small overlap frontal crash. After the colliding body abuts on the front protrusion of the extension, the loads are transmitted to and absorbed by the front side member via the rear protrusion. More specifically, assume a case where a weakened portion such as a crash box is provided at the front of the front side member. In this case, if a small overlap crash occurs and a vehicle as a colliding body hits the extension of the bumper reinforcement, the front protrusion protruding ahead of the bumper reinforcement abuts on the colliding body first, and the rear protrusion provided on the rear side of the extension then receives the impact and abuts on the crash box from outside, having the crash box undergo bending deformation. Partial pressure is thus generated in the vehicle width direction, allowing the loads to be absorbed. As a result, even if the relative position between the colliding body and the vehicle varies at the time of a small overlap frontal crash, the loads can be absorbed stably.

### BRIEF DESCRIPTION OF THE DRAWINGS

The foregoing and further objects, features and advantages of the invention will become apparent from the following description of example embodiments with reference to the accompanying drawings, wherein the same or corresponding portions will be denoted by the same reference numerals and wherein:

FIG. 1 is an oblique perspective view of a vehicle front structure according the embodiment of the present invention.

FIG. 2 is a plan view showing one side of the vehicle front structure in the vehicle width direction according to the embodiment of the present invention.

FIGS. 3 (a) and (b) are schematic diagrams of the vehicle front structure according to the embodiment of the present invention describing the state of deformation in the case of a frontal crash.

FIG. 4 (a) to (c) are schematic diagrams of the vehicle front structure according to the embodiment of the present invention describing the state of deformation in the case of a small frontal overlap crash.

### DESCRIPTION OF EMBODIMENT

The embodiment of the present invention will hereinafter be described in detail by referring to the drawings. The following detailed description is merely exemplary in nature and is not intended to limit the present invention and uses. Furthermore, there is no limitation to be bound by any theory presented in the preceding background or the following detailed description. In the drawings, F represents the front side, R represents the rear side, and W represents the width direction of the vehicle.

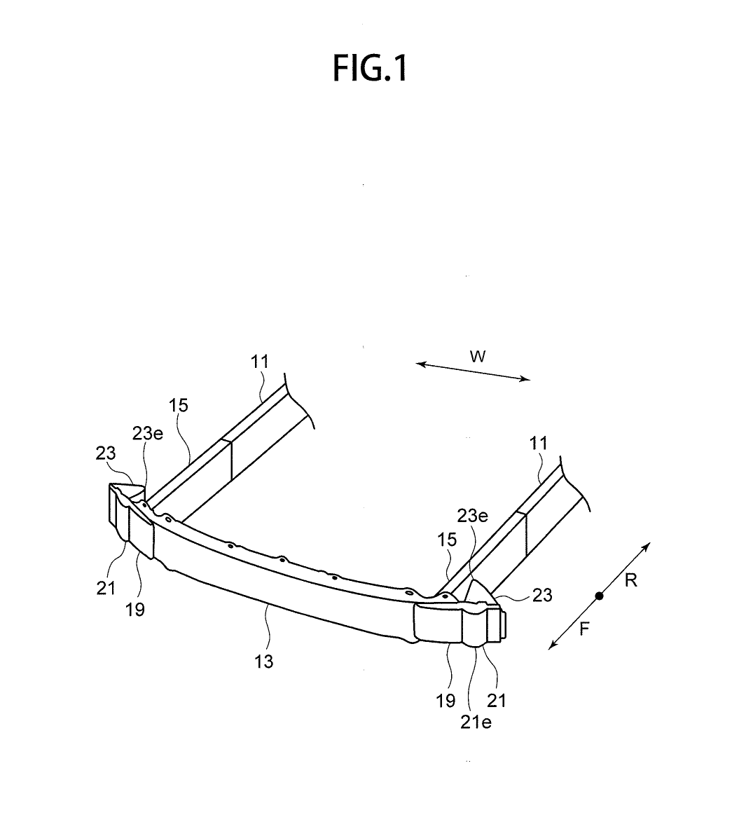

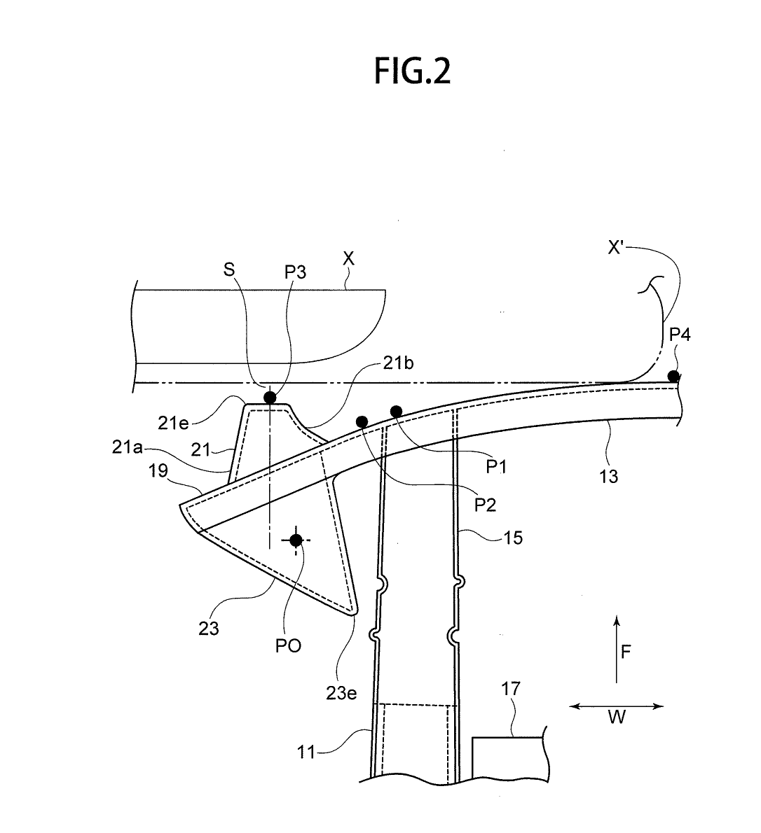

As shown in FIGS. 1 and 2, in a vehicle front structure according to the embodiment of the present invention, a pair of front side members 11 is provided on both sides in the vehicle width direction W, extending in the vehicle front-rear direction F, R, and supporting a bumper reinforcement 13 in the vehicle width direction at the front part of each front side member 11.

A pair of weakened portions 15 is provided in the front part of the front side members 11 in a state connected to the front side members 11, and the bumper reinforcement 13 is fastened to the front end of each weakened portion 15. The weakened portions 15 are respectively fastened to the rear face of the bumper reinforcement 13 on the left and the right sides, and are formed as an integral part of the front side member 11 by weakening the rigidity of the front part of the front side member 11. The weakened portion 15 may also be formed by connecting a crash box that has been formed separately from the highly rigid front side member main body. The weakened portion 15 is provided in a place at least ahead of a transmission 17 of a driving system and up to the bumper reinforcement 13.

On the outside of each of the front side members 11 in the vehicle width direction W, an extension 19 is provided in a form extending from the bumper reinforcement 13. The extension 19 may be formed separately from the main body of the bumper reinforcement 13 and by connecting it at the end of the bumper reinforcement 13. In this embodiment, however, the extension 19 is integrated into and constituting a part of the bumper reinforcement 13. The extensions 19 are provided on both sides in the vehicle width direction W, and supported by the front side members 11 with their front end remaining as a free end. The extensions 19 on the left and the right sides are curved moderately toward the rear side of the vehicle along the direction toward the outside in the vehicle width direction, and the length of the curving extension in a longitudinal direction is set shorter than the length of the weakened portion 15 in the vehicle front-back direction.

As shown in FIGS. 1 and 2, a front protrusion 21 is provided on the front side of each extension 19 in the vehicle front-rear direction F, R. Each front protrusion 21 is integrated with the extension 19 into one piece, but may be formed separately and connected to the extension 19. The front protrusion has, on the front side of the extension 19, a front end 21e positioned forward toward the front side of the vehicle, a vertical wall 21a provided on the outside in the vehicle width direction, and a vertical wall 21b provided on the inside in the vehicle width direction. The vertical wall 21a on the outside in the vehicle width direction is formed longer, in the vehicle front-rear direction, than the vertical wall on the inside in the vehicle width direction.

The front end 21e of the front protrusion 21 remains ahead of the bumper reinforcement 13 at a position outside of the place supported by the front side member 11. Specifically, it is preferable that P3, the position of the front end 21e and the foremost part of the front protrusion 21, be arranged ahead of P1, P2, positions on the front end of the bumper reinforcement 13. By setting the amount of protrusion of the front protrusion 21 appropriately, the positions where the loads from the colliding body X (FIG. 2) are imposed at the time of a small overlap frontal crash can be stabilized.

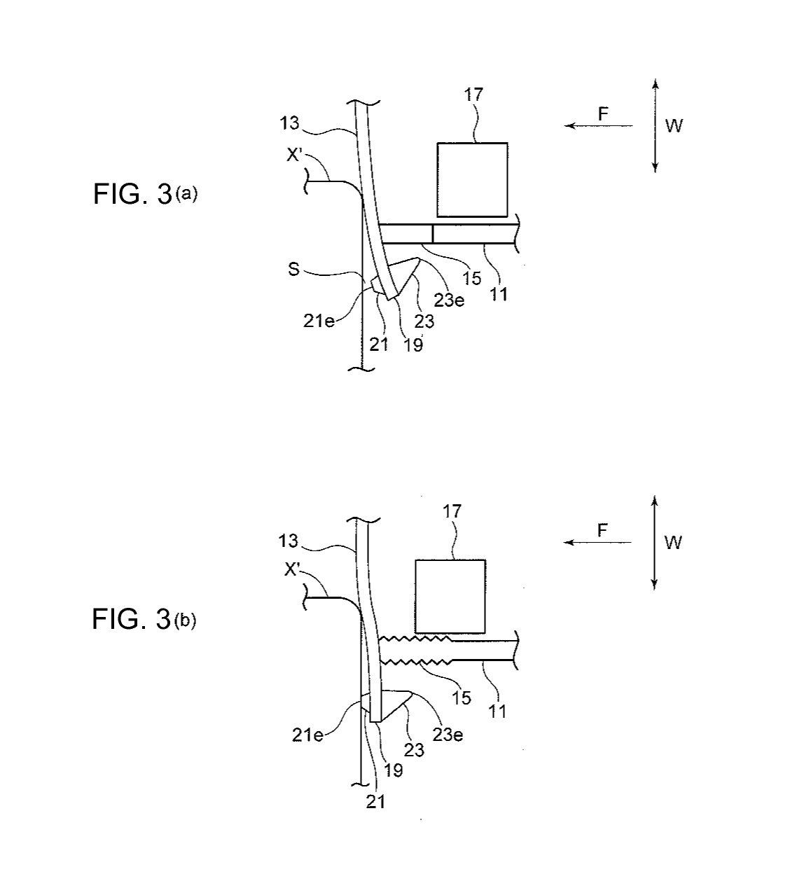

Meanwhile, P3, the position of the front end 21e of the front protrusion 21, is positioned, in the vehicle front-rear direction, behind P4, the foremost edge of the bumper reinforcement 13. In other words, as shown in FIG. 2 and FIG. 3 (a), a gap in the front-rear direction shown as space S is allowed between the initial contact position of the front end 21e at the time of a small overlap frontal crash and the initial contact position of the bumper reinforcement 13 at the time of a frontal crash. Consequently, when a frontal crash occurs, space S is allowed between the front end 21e and the colliding body X′. Since this space S is for causing deformation to occur, it is to be referred to as deformation space S.

FIG. 2 is a plan view showing the left side of the vehicle front structure in the vehicle width direction. As shown well in the FIG. 2, a part or the whole of the front end 21e of the front protrusion 21 is arranged on the outside of the center of gravity PO of the rear protrusion 23 in the vehicle width direction W. As described previously, the vertical wall 21a of the front protrusion 21 on the outside in the vehicle width direction is formed longer, in the front-rear direction, than the vertical wall 21b on the inside in the vehicle width direction. The extension 19 is thus allowed to undergo bending deformation without fail and the weakened portion 15 is inhibited from undergoing crushing deformation in the axial direction. When loads are imposed on the front protrusion 21, the weakened portion 15 is thus inhibited from undergoing crushing deformation, and bending deformation thus occurs easily as described later.

In addition, on the rear side of the extension 19 in the front-rear direction F, R of the vehicle, a rear protrusion 23 is provided. The rear protrusion 23 protrudes toward the central part of the weakened portion 15 in the vehicle front-rear direction, and arranged in a state apart from the weakened portion 15. Furthermore, the rear protrusion 23 has a triangular cross section tapered toward the rear side, and the gap with the weakened portion 15 becomes narrower toward the rear side. It is preferable that the rear protrusion 23 be formed at a position overlapping with the front protrusion 21 in the vehicle width direction W viewed from the front to ensure that the rear protrusion 23 is displaced in a specified direction when the front protrusion 21 abuts on the colliding body X.

The behavior of the above-mentioned vehicle front structure will hereinafter be described.

At the time of a frontal crash, as shown in FIG. 3 (a), the foremost edge of the bumper reinforcement 13 (around P4 in FIG. 2) arranged between the front side members 11 on both sides in the vehicle width direction W abuts on a colliding body X′, such as a head-on barrier, as the initial contact position. In this case, deformation space S is allowed between the front end 21e of the front protrusion 21 and the colliding body X′. If loads are imposed from the front to the bumper reinforcement 13 between the front side members 11, the front protrusion 21 and the extension 19 deform toward the deformation space S due to inertial force. Accordingly, the rear protrusion 23 displaces toward the front side of the vehicle. The rear protrusion 23 thus moves in a direction leaving from the weakened portion 15, and deforms. The rear protrusion 23 neither abuts on the weakened portion 15 of the front side member 11 nor inhibits the behavior of the weakened portion 15. As shown in FIG. 3 (b), deformation progresses in this state, and the weakened portion 15 is compressed and deformed in the axial direction due to the loads from the bumper reinforcement 13, absorbing the impact loads.

Meanwhile, in the case of a small overlap frontal crash within expected condition range, at the specified speed or lower for example, the rigidity of the bumper reinforcement 13 and the extension 19, etc. allows counterforce in the vehicle width direction W to be produced so that the vehicle can escape from the colliding body X.

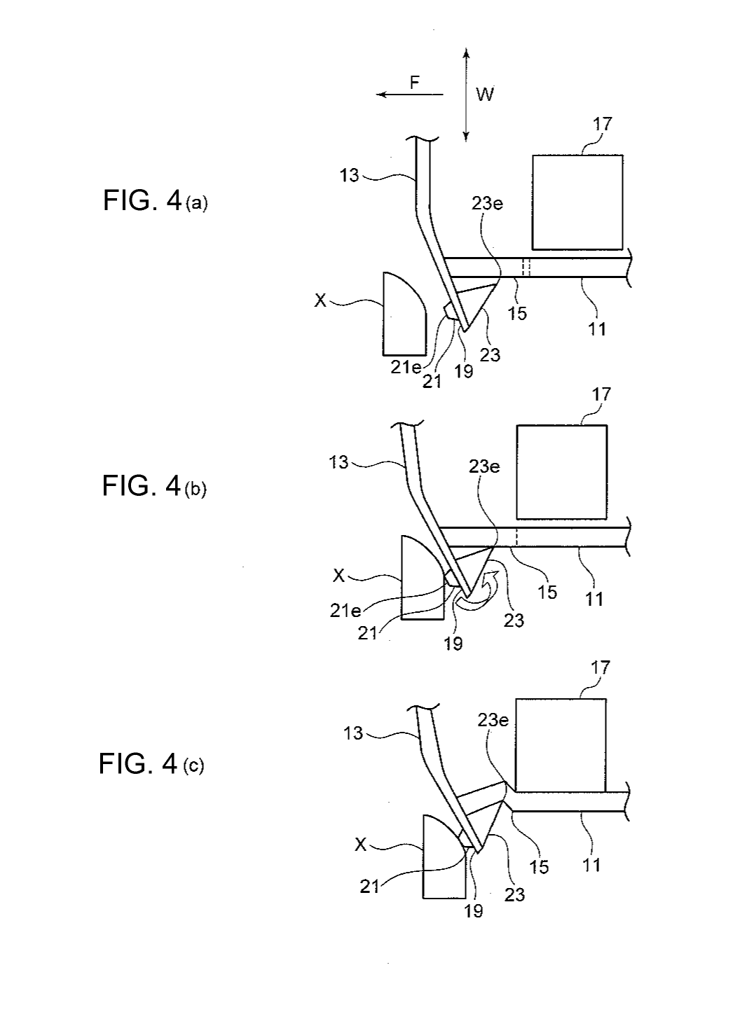

In the case of a small overlap frontal crash exceeding the expected condition range, as shown in FIG. 4 (a) to (c), the vehicle front structure deforms and absorbs impact loads. First, with the positional relation as shown in FIG. 4 (a), the front protrusion 21 of the extension 19 on the outside of the front side member 11 collides against the colliding body X such as a small overlap barrier, causing a small overlap frontal crash to occur. At this time, as shown in FIG. 4 (b), the front end 21e of the front protrusion 21 abuts on the colliding body X as the initial contact position. Consequently, the extension 19 is pressed down at the position of the front protrusion 21, causing rotational deformation around the supported part to occur.

Consequently, the inner tip 23e of the rear protrusion 23 provided on the rear face side of the extension 19 abuts on the weakened portion 15 of the front side member 11. Since the inner tip 23e is arranged, facing the weakened portion 15 at an intermediate position between the bumper reinforcement 13 and a transmission 17, the inner tip 23e of the rear protrusion 23 abuts on the weakened portion 15 at this intermediate position. Then the loads imposed on the outside of the front side member 11 in the vehicle width direction W is transmitted to the front side member 11 via the extension 19. In other words, the loads press down the weakened portion 15 via the rear protrusion 23.

The intermediate position of the weakened portion 15 in the front-rear direction of the vehicle is pressed down by the inner tip 23e of the rear protrusion 23 as shown in FIG. 4 (c). As a result, the weakened portion 15 is made to undergo bending deformation, whereas the transmission 17 is not damaged because the rear protrusion 23 does not abut on it. This deformation of the weakened portion 15 absorbs the loads of the small overlap frontal crash.

According to such a vehicle front structure, since the extension 19 is provided with the front protrusion 21 protruding ahead of the bumper reinforcement 13, the front protrusion 21 is allowed to abut on the colliding body X, at the time of a small overlap frontal crash, even if the relative position between the colliding body X and the vehicle varies in the vehicle width direction W when loads are imposed on the extension 19 from the colliding body X at the front. The positions where the loads are imposed from the colliding body X at the front to the extension 19 at the time of a small overlap frontal crash can thus be stabilized.

Specifically, assume that the relative position of the colliding body X and the vehicle varies by 1% of the width of the vehicle when no front protrusions 21 are provided, and the position where the colliding body X abuts on the vehicle front structure changes from P1 to P2 (FIG. 2). At position P1, the weakened portion 15 is crushed and deformed in the axial direction, whereas at position P2, the extension 19 deforms in the vehicle width direction W. The deformation of the vehicle front structure due to application of the loads and the amount of absorbed loads are thus found to vary significantly.

Meanwhile, since the front protrusions 21 are provided in the embodiment of the present invention, the contact position between the colliding body X and the vehicle front structure remains at P3, meaning that the position where the loads are imposed does not change, even if the relative position between the colliding body X and the vehicle varies by 1% of the width of the vehicle. As a result, even if the relative position between the colliding body X and the vehicle varies in the vehicle width direction at the time of a small overlap frontal crash, the loads can be absorbed stably. The amount of loads to be absorbed by the extensions 19 and the front side members 11 as well as the deformation of the front side members 11 can thus be stabilized.

Furthermore, in such a vehicle front structure, weakened portions 15 are provided at the front part of the front side members 11, and the extensions 19 are provided with a rear protrusion 23 protruding toward the weakened portion 15 in a state not connected to the weakened portion 15. Consequently, if the extension 19 deforms due to a small overlap frontal crash, the loads are transmitted to and absorbed by the weakened portion 15 via the rear protrusion 23. Meanwhile, at the time of a frontal crash, the rear protrusion 23 does not inhibit the behavior of the weakened portion 15 of the front side member 11. Deformation mode can thus be made to differ between a frontal crash and a small overlap frontal crash, and a deformation mode suitable for each applies. The front end 21e of the front protrusion 21 is at a position, in the vehicle front-back direction, behind the foremost edge of the bumper reinforcement 13 arranged between the front side members 11. Further, deformation space S for a front crash is provided ahead of the front end 21e. Interference with the weakened portion 15 by the rear protrusion 23 can thus be prevented without fail at the time of a frontal crash.

Furthermore, since the front end 21e of the front protrusion 21 is positioned outside of the center of gravity PO of the rear protrusion in the vehicle width direction, the extension 19 deforms toward the weakened portion 15 at the time of a small overlap frontal crash, ensuring stable impact absorption. In the case of this vehicle front structure, the weakened portion 15 can be compressed and deformed in the axial direction at the time of a frontal crash, whereas if the loads applied to outside of the front side member 11 in the vehicle width direction W are transmitted via the rear protrusion 23, bending deformation is allowed. In other words, the deformation mode can be made to differ significantly between a frontal crash and a small overlap frontal crash. As a result, stable impact absorption can be achieved without affecting the impact absorption performance at the time of a frontal crash, even if the relative position between the colliding body X and the vehicle varies in the vehicle width direction at the time of a small overlap frontal crash.

Furthermore, since the rear protrusion 23 is in a form tapered toward the rear side of the vehicle, the gap with the weakened portion 15 becomes narrower toward the rear. The load can thus be focused on the inner tip 23e of the rear protrusion 23, facilitating bending deformation of the weakened portion 15 at the time of a small overlap frontal crash.

The embodiment of the present invention is not limited to the one described above, but can be modified as required within the scope of the present invention. For example, the case where the weakened portion 15 is integrated into a rigid front side member main body by decreasing the rigidity of the part near the front end of the front side member 11 was described. However, the embodiments are not limited to this one. The weakened portion 15 may be a crash box mounted between the rigid main body of the front side member 11 and the bumper reinforcement 13. In addition, the shape of the front protrusion 21 and that of the rear protrusion 23 can be modified as required, provided that the change in the impact of the colliding body due to the variation of the shape of the barriers at the time of a test, for example, can be absorbed.

### REFERENCE SIGNS LIST

W: Vehicle width direction
F, R: Vehicle front-rear direction
X: Colliding body
S: Deformation space
11: Front side member
13: Bumper reinforcement
15: Weakened portion
17: Transmission
19: Extension
21: Front protrusion
21e: Front end
23: Rear protrusion
23e: Inner tip

What is claimed is:

1. A vehicle front structure, comprising:
a pair of front side members arranged on both sides of a vehicle in a vehicle width direction and extending in a vehicle front-rear direction;
a bumper reinforcement arranged in the vehicle width direction at a front part of the front side members; and
extensions of the bumper reinforcement arranged at positions outside of the front side members in the vehicle width direction, wherein
each extension has, on its front side, a front protrusion protruding forward from the bumper reinforcement at a position outside of where each of the pair of front side members is arranged, and on its rear side,
a rear protrusion protruding backward from the bumper reinforcement at a position outside of where each of the pair of front side members is arranged, and
loads imposed on the extension at positions outside of the front side member in the vehicle width direction at the time of a small overlap frontal crash are transmitted to the front side member by the rear protrusion via the front protrusion of the extension.

2. The vehicle front structure as set forth in claim 1, wherein a pair of weakened portions is connected to the front side members as their front portions to weaken the rigidity of the front side members around their front ends and respectively fastened to the rear face of the bumper reinforcement on left and right sides.

3. The vehicle front structure as set forth in claim 2, wherein the weakened portion can undergo compression deformation in an axial direction at the time of a frontal crash.

4. The vehicle front structure as set forth in claim 2, wherein abutting of the rear protrusion of the extension allows the weakened portion to undergo bending deformation at the time of a small overlap frontal crash.

5. The vehicle front structure as set forth in claim 2, wherein the weakened portion is a crash box mounted between the front side member and the bumper reinforcement.

6. The vehicle front structure as set forth in claim 1, wherein the extension is integrated into and constituting a part of the bumper reinforcement.

7. The vehicle front structure as set forth in claim 1, wherein the extension is curved moderately toward the rear side of the vehicle along a direction toward the outside in the vehicle width direction, and the length of the curving extension is set shorter than the length of the weakened portion in the vehicle front-rear direction.

8. The vehicle front structure as set forth in claim 1, wherein the extension allows the rear protrusion to be displaced in a specified direction when the front protrusion abuts on a colliding body at the time of a small overlap frontal crash.

9. The vehicle front structure as set forth in claim 1, wherein the front protrusion has a front end positioned forward toward the front of the vehicle, a vertical wall on outside in the vehicle width direction, and a vertical wall on inside in the vehicle width direction, and the vertical wall on outside in the vehicle width direction is formed longer than the vertical wall on inside in the vehicle width direction.

10. The vehicle front structure as set forth in claim 1, wherein the front end of the front protrusion is arranged on outside of the center of gravity of the rear protrusion in the vehicle width direction.

11. The vehicle front structure as set forth in claim 1, wherein the front end of the front protrusion is arranged by allowing a specified gap from the foremost edge of the bumper reinforcement in the vehicle front-rear direction so that the front end remains behind the foremost edge of the bumper reinforcement mounted between the front side members.

12. The vehicle front structure as set forth in claim 1, wherein the front end of the front protrusion is positioned ahead of the foremost edge of the bumper reinforcement at positions outside of the part supported by the front side member.

13. The vehicle front structure as set forth in claim 1, wherein the rear protrusion protrudes toward the center of the weakened portion in the vehicle front-rear direction, and is arranged in a state not connected with the weakened portion.

14. The vehicle front structure as set forth in claim 12, wherein the rear protrusion is in a form tapered toward a rear side, and a gap with the weakened portion becomes narrower toward the rear side.

15. The vehicle front structure as set forth in claim 1, wherein the rear protrusion is arranged at a position overlapped with the front protrusion in the vehicle width direction when viewed from the front.

16. The vehicle front structure as set forth in claim 1, wherein at the time of a frontal crash, the front protrusion and the extension deform toward the front side of the vehicle, and accordingly the rear protrusion displaces toward the front side of the vehicle.

17. The vehicle front structure as set forth in claim 1, wherein at the time of a small overlap frontal crash, the front protrusion abuts on a colliding body at an initial contact position, pressing down the extension toward the rear of the vehicle, and accordingly the rear protrusion contacts the weakened portion, thereby having the weakened portion undergo bending deformation.
